(19) United States
(12) Patent Application Publication
(10) Pub. No.: US 2023/0195673 A1
(43) Pub. Date: Jun. 22, 2023

(54) PLUGGABLE DATA ADAPTOR

(71) Applicant: Rakuten Mobile, Inc., Tokyo (JP)

(72) Inventors: Jyoti BOSE, Mumbai (IN); Mihirraj Narendra DIXIT, Tokyo (JP); Surender Singh LAMBA, Tokyo (JP); Abhishek SHARMA, Tokyo (JP)

(21) Appl. No.: 17/644,592

(22) Filed: Dec. 16, 2021

(51) Int. Cl. G06F 13/40; G06F 13/16; G06F 9/4401; G06F 9/54; G06F 9/48

(52) U.S. Cl. CPC G06F 13/4081; G06F 13/1668; G06F 9/4411; G06F 9/542; G06F 9/4881

(57) ABSTRACT

A system includes processing circuitry and a memory connected to the processing circuitry. The memory is configured to store executable instructions that, when executed by the processing circuitry, cause the processing circuitry to startup a configuration parser module and an invoke worker module. To obtain a configuration file from a database where the configuration file specifies configuration information for constructing a pluggable event gate that includes a data adaptor for an online source, a data adaptor for an offline source, a data adaptor sink. To construct one or more event gates based on the configuration file. The configuration file further specifies one or more user-defined data sources and one or more user-defined data sinks. To create, responsive to a number of the user-defined data sources and a number of user-defined data sinks, multiprocessing workers located on one or more cores of a network and share data between the multiprocessing workers.

### BACKGROUND

Event-driven architecture (EDA) is a software architecture paradigm promoting the production, detection, consumption of, and reaction to events. An event is defined as a change in state. What is produced, published, propagated, detected or consumed is a message called the event notification, and not the event itself, which is the state change that triggered the message emission. Events do not travel, events just occur. However, the term event is often used metonymically to denote the notification message itself. The EDA is often designed atop message-driven architectures, where such a communication pattern requires one of the inputs to be text-only (e.g., the message) to differentiate how each communication should be handled.

In computing, being pluggable (or plugin, add-in, addin, add-on, or addon) references a software component that adds a specific feature to an existing computer program. When a program supports plug-ins, the program enables customization.

### BRIEF DESCRIPTION OF THE DRAWINGS

Aspects of the present disclosure are best understood from the following detailed description when read with the accompanying FIGS. In accordance with the standard practice in the industry, various features are not drawn to scale. In fact, the dimensions of the various features be arbitrarily increased or reduced for clarity of discussion.

FIG. 1 is a block diagram representation of an event gate system, in accordance with some embodiments.

FIG. 2 is a pictorial representation of a pluggable data adaptor, in accordance with embodiments of the present invention.

FIG. 3 is a flow diagram for a method of implementing a pluggable data adaptor, in accordance with some embodiments.

FIG. 4 is a high-level functional block diagram of a data adaptor processor-based system, in accordance with some embodiments.

### DETAILED DESCRIPTION

The following disclosure includes many different embodiments, or examples, for implementing different features of the subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact, and also include embodiments in which additional features be formed between the first and second features, such that the first and second features not be in direct contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, be usable herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus be otherwise oriented (rotated 90 degrees or at other orientations) and the spatially relative descriptors usable herein likewise be interpreted accordingly.

In some embodiments, a pluggable data adaptor for online and offline data sources is disclosed. A data adapter functions as a bridge between a data source and a disconnected data class, such as a data set. At the simplest level it will specify structured query language (SQL) commands that provide elementary create, read, update, and delete (CRUD) functionality. At a more advanced level data adaptors offer the functions required in order to create strongly typed data sets, including data relations. In addition to adapters, managed providers include connection objects, data reader objects, and command objects. Data adapters are used to exchange data between a data source and a dataset. In many applications, this means reading data from a database into a dataset, and then writing changed data from the dataset back to the database.

In some embodiments, an event gate is a pluggable data adaptor that connects with multiple types of data sources to collect data, such as event messages. In some embodiments, the event messages are collected via a data stream, batch data, online data, and offline data. In some embodiments, the event gate is based on business logic. In computer software, business logic or domain logic is the part of a software program that encodes the real-world business rules that determine how data is created, stored, and changed. Business logic is contrasted with the remainder of the software program that is concerned with lower-level details of managing a database or displaying the user interface, system infrastructure, or generally connecting various parts of the program.

In programming and software design, an event is a change of state (e.g., an action or occurrence) recognized by software, often originating asynchronously from the external environment that is handled by the software. Computer event messages are generated or triggered by a system, by a user, or in other ways based upon the event. Event messages are handled synchronously with the program flow; that is, the software is configured to have one or more dedicated places where event messages are handled; frequently an event loop. A source of event messages includes the user, who interact with the software through the computer's peripherals; for example, by typing on the keyboard. Another source is a hardware device such as a timer. Software is configured to also trigger its own set of event messages into the event loop (e.g. to communicate the completion of a task). Software that changes its behavior in response to event messages is said to be event-driven, often with the goal of being interactive.

In some embodiments, based on business logic the collected event messages are grouped into frames. Frames are an artificial intelligence data structure used to divide knowledge into substructures by representing stereotyped situations. Frames are the primary data structure used in artificial intelligence frame language; frames are stored as ontologies of sets. In computer science and information science, an ontology encompasses a representation, formal naming and definition of the categories, properties and relations between the concepts, data and entities that substantiate one, many, or all domains of discourse. An ontology is a way of showing the properties of a subject area and how the properties are related, by defining a set of concepts and categories that represent the subject. Frames are also an extensive part of knowledge representation and reasoning schemes. Structural representations assemble facts about a particular object and event message types and arrange the event message types into a large taxonomic hierarchy.

In some embodiments, the frames are produced over a messaging que, such as a real-time transmission control protocol (TCP) messaging queue, TCP/UDP messaging, or other suitable communications messaging in accordance with some embodiments. Real-time or real time describes operations in computing or other processes that guarantee response times within a specified time (deadline), usually a relatively short time. A real-time process is generally one that happens in defined time steps of maximum duration and fast enough to affect the environment in which the real-time process occurs, such as inputs to a computing system. In computer science, message queues and mailboxes are software-engineering components typically used for inter-process communication (IPC), or for inter-thread communication within the same process. Message queues use a queue for messaging; the passing of control or of content.

In some embodiments, the behavior of the pluggable data adapter is modified on the fly without changing software code or stopping the server. On the fly is a phrase used to describe something that is being changed while the process that the change affects is ongoing. In programming, on the fly describes changing a program while the program is still running. In some embodiments, the pluggable data adapter is configured to switch between many data sources and data sinks. In computing, a sink, event sink or data sink is a class or function designed to receive incoming event messages from another object or function.

An EDA architectural pattern is applied by the design and implementation of applications and systems that transmit event messages among loosely coupled software components and services. An event-driven system typically consists of event emitters (or agents, data sources), event consumers (or sinks), and event channels (or the medium the event messages travel from emitter to consumer). Event emitters detect, gather, and transfer event messages. An event emitter does not know the consumers of the event messages, the event emitter does not even know if an event consumer exists, and in case the event consumer exists, the event emitter does not know how the event message is used or further processed. Event consumers apply a reaction as soon as an event message is presented. The reaction is or is not completely provided by the event consumer. For example, the event consumer filters, transforms and forwards the event message to another component or the event consumer supplies a self-contained reaction to such event message. Event channels are conduits in which event messages are transmitted from event emitters to event consumers. The configuration of the correct distribution of event messages is present within the event channel. The physical implementation of event channels is based on components, such as message-oriented middleware or point-to-point communication, which might rely on a more appropriate transactional executive framework.

Event driven service-oriented architecture (SOA) combines the intelligence and proactiveness of event-driven architecture with the organizational capabilities found in service offerings. Before event-driven SOA, the typical SOA platform orchestrated services centrally, through pre-defined business processes, assuming that what should have already been triggered is defined in a business process. This older approach does not account for event messages that occur across, or outside of, specific business processes. Thus complex event messages, in which a pattern of activities, both non-scheduled and scheduled, should trigger a set of services that are not accounted for in other approaches.

Other EDA or SOA approaches are not configured to support a single solution for several or multiple types of data, data collectors or data sources. Further, other EDA or SOA approaches do not support collecting data in both data streams and in batch data. In computer science, a stream is a sequence of data elements made available over time. A stream is thought of as items on a conveyor belt being processed one at a time rather than in large batches. Streams are processed differently from batch data. Normal functions cannot operate on streams as a whole, as the streams have potentially unlimited data, and formally, streams are co-data (potentially unlimited), not data (which is finite). Functions that operate on a stream, producing another stream, are known as filters, and are connected in pipelines, analogously to function composition. Filters operate on one item of a stream at a time, or base an item of output on multiple items of input, such as a moving average. Computerized batch processing is the running of jobs that can run without end user interaction, or is scheduled to run as resources permit.

Other EDA or SOA approaches do not have a layer to group data based on business logic. In some embodiments, the software code and configuration to use the service layer are separated. In SOA, the service layer is a layer in a multi-layer-abstraction-layer model. The model consists of an object layer, component layer, service layer, process layer and enterprise layer. The service layer is considered as a bridge between the higher and lower layers, and is characterized by a number of services that are carrying out individual business functions. In some embodiments, the service layer understands the configuration and creates multiple event gates (e.g., data adapters) based on the received configurations. In some embodiments, event gates abstract a data source and data sink and support a faster solution of the data compared to other approaches.

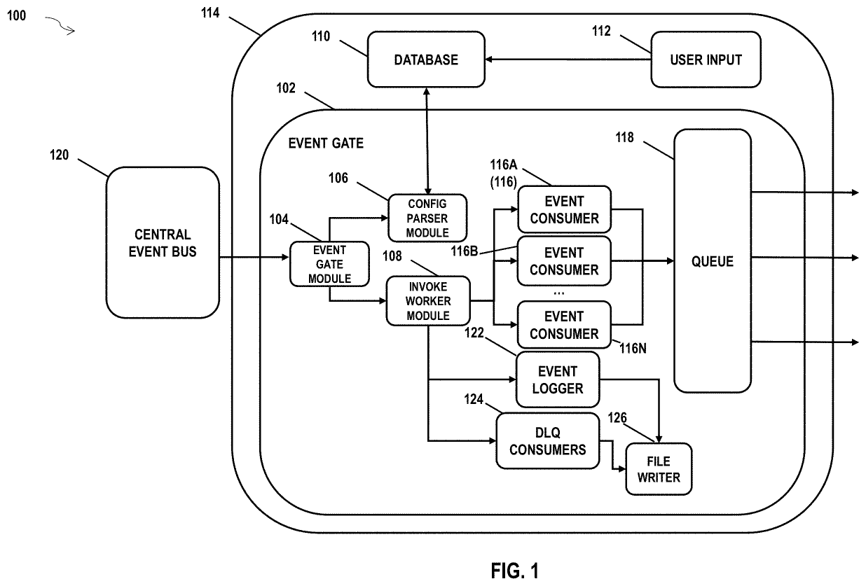

FIG. 1 is a flow diagram representation of an even gate system 100, in accordance with some embodiments.

Even gate system 100 includes event gate 102, which includes an event gate module 104, a configuration parser module 106 and an invoke worker module 108. A correlation engine is a software application that programmatically understands relationships. Correlation engines are used in systems management tools to aggregate, normalize and analyze event log data, using predictive analytics and fuzzy logic to alert the systems administrator when there is a problem, and repair and scaling use cases in radio access networks (RAN) and/or core networks. In some embodiments, even gate system 100 is a part of an enterprise software platform.

In some embodiments, a service layer of even gate system 100 understands the configuration file inputted by a user at user input 112 and creates multiple event gates 102 based on the received configuration file. Event gate module 104 is the master process within event gate 102 and responsible for starting configuration parser module 106 and invoke worker module 108. In some embodiments, event gate module 104 delegates tasks, based upon a configuration file, to all other modules within event gate 102. In some embodiments, this start up is performed sequentially. In some embodiments, the startup is performed concomitantly. Event gate module 104 further receives event messages from central event bus 120. Event messages are from online data sources, offline data sources, streaming data sources and batch data sources. In some embodiments, event gate module 104 is configurable through an event gate template for the event gate's data source and data sink. In some embodiments, an event gate template is an open standard file format and data interchange format that uses human-readable text to store and transmit data objects consisting of attribute—value pairs and arrays (or other serializable values). In some embodiments, an event gate template is a data format with a diverse range of functionality in data interchange including communication of web applications with servers. In some embodiments, event gate module 104 is configured to consume data from many sources.

Central event bus 120 is a framework implementation of a software bus using stream-processing. In some embodiments, central event bus 120 is an open-source software platform. In some embodiments, central event bus 120 provides a unified, high-throughput, low-latency platform for handling real-time data feeds. In some embodiments, central event bus 120 connects to external systems (for data import/export). In some embodiments, central event bus 120 uses a binary messaging protocol that is optimized for efficiency and on a message-set abstraction that naturally groups messages together to reduce the overhead of the network roundtrip. In some embodiments, the message-set abstraction leads to larger network packets, larger sequential disk operations, contiguous memory blocks which allows central event bus 120 to turn a bursty stream of random message writes into linear writes.

Configuration parser sub-module 106 queries database 110 for a defined configuration. In some embodiments, event gate 102 is configured to use configuration parser module 106 to parse the configuration file inputted by a user at through user input 112. In some embodiments, based on the configuration file, a user knows the number of data sources and the configuration of each data source and the configuration of every event consumer 116 that is to be spawned by invoke worker module 108. In some embodiments, the configuration file includes a predefined data source and data sink. In some embodiments, the configuration file is inputted, modified, and controlled by a user through user input 112. In some embodiments, the user inputs, modifies, and controls the configuration file in real time. In some embodiments, database 110 and/or user input 112 are located within a correlation engine and policy manager (CPE).

Enterprise software, also known as enterprise application software (EAS), is computer software used to satisfy needs of an organization rather than individual users. Such organizations include businesses, schools, interest-based user groups, clubs, charities, and governments. Enterprise software is a part of a (computer-based) information system; a collection of such software is called an enterprise system. These systems handle a chunk of operations in an organization with the aim of enhancing the business and management reporting tasks. The systems process the information at a relatively high speed and is deployed across a variety of networks. Services provided by enterprise software are typically business-oriented tools, such as online shopping, and online payment processing, interactive product catalogue, automated billing systems, security, business process management, enterprise content management, information technology (IT) service management, customer relationship management, enterprise resource planning, business intelligence, project management, collaboration, human resource management, manufacturing, occupational health and safety, enterprise application integration, and enterprise forms automation.

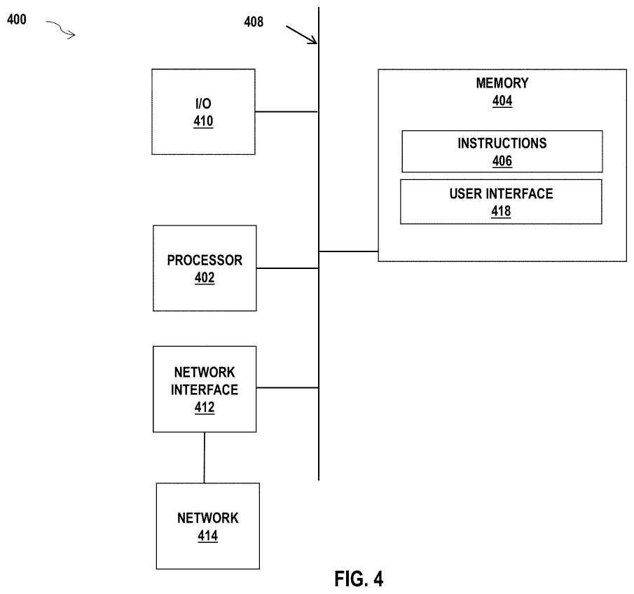

In some embodiments, based on a number of data sources and data sinks configuration parser module 106 forwards to invoke worker module 108 an instruction to spawn multiprocessing workers or event consumers 116A, 116B, . . . 116N (where N is a non-negative integer) (herein referred to as event consumers 116) on each core of a system with a shared queue 118. In some embodiments, core refers to a central processing unit (CPU), also called a central processor, main processor or just processor and is the electronic circuitry that executes instructions comprising a computer program. In some embodiments, the core is processing circuitry 402 of FIG. 4. The core performs basic arithmetic, logic, controlling, and input/output (I/O) operations specified by the instructions in a program. In some embodiments, the system is a group of computers or cores that are linked and function together, such as a computer network or computer cluster. In some embodiments, shared queue 118 is for data sharing between the event consumers.

In some embodiments, configuration parser module 106 is a data model parser that parses the configuration file. In some embodiments, a data model parser is primarily a parsing library and not a validation library. In other words, a data model parser assures the types and constraints of the output model, not the input data based on the configuration file. In some embodiments, all parameters are obtained and set based upon the configuration file. In some embodiments, the configuration file details all read, write and execute permissions for event gate module 104, invoke worker module 108 and event consumers 106.

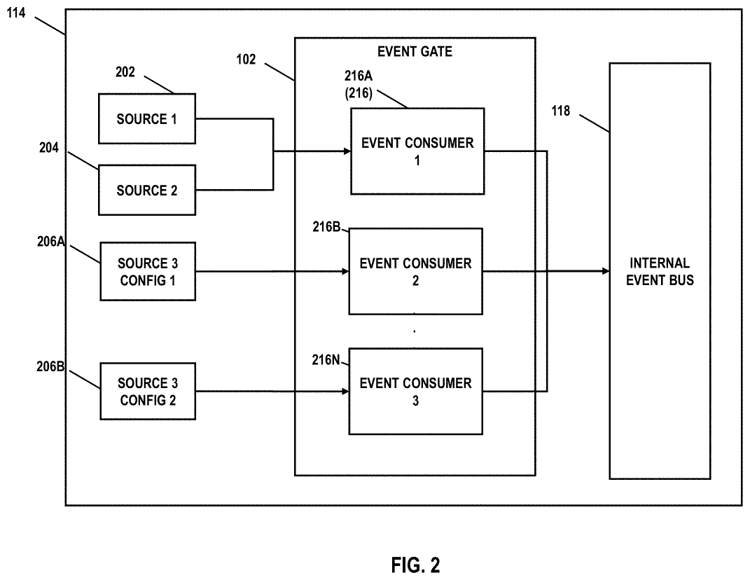

In some embodiments, event consumers 116 write event frames to shared queue 118 where the event frames is a collection of events. In some embodiments, a unique event identification is added to every event frame. In some embodiments, every event consumer 116 has a unique identification. In some embodiments, one or more event consumers 116 are disabled, refreshed or suspended based upon the unique identification. In some embodiments, each event consumer allows for multiple data sources and customized configurations (FIG. 2). In some embodiments, based on the configuration file, event consumers 116 will consume event messages from the configuration file designated data source and send the event message to the data sink; shared queue 118.

In some embodiments, shared queue 118 is an asynchronous messaging library, aimed at use in distributed or concurrent applications. In some embodiments, shared queue 118 provides a message queue, but unlike message-oriented middleware, a shared queue system runs without a dedicated message broker. In some embodiments, each event consumer has its own data source and data sink definition to which the event consumer attaches read and write data.

In some embodiments, event logger 122 reads shared queue 118 that is populated by event consumers 116 and logs the information to a file. In some embodiments, disqualification (DLQ) consumers 124 take any event that creates an error by event consumers 116 and consumes the error creating event. In some embodiments, DLQ consumers 124 creates an error log with the error creating event and the error creating event is written via file writer 126. In some embodiments, file writer 126 writes logs of event gate 102 to a file. In some embodiments, file writer 126 maintains rolling logs based on timestamp and size.

FIG. 2 is a pictorial representation of a pluggable data adaptor, in accordance with embodiments of the present invention.

In FIG. 2, reference numbers from FIG. 1 are reused for similar elements from FIG. 1 for the sake of brevity and clarity. This is not to say the embodiments of FIG. 1 and FIG. 2 are the same as these figures differ and the different elements are renumbered with new reference numerals.

In some embodiments, a user is able to add a data source configuration via an application programming interface (API) server. In some embodiments, based upon the configuration entered by the user, invoke worker module, such as invoke worker module 108, will specify a configuration to each event consumers 216.

In an example, event consumer (1) 216A is configured to consume multiple sources (e.g., source (1) 202 and source (2) 204). Event consumer (2) 216B and event consumer (3) 216N have the same source 206A and 206B, but the configuration for each source 206A and 206B is different. In an example, configuration (1) for source (3) 206A is set by the user and is set for event consumer (2) to consume based on aggregated time window (e.g., batch processing). Configuration (2) for source (3) 206B is set by the user and is for event consumer (3) 206B that is consuming events one after the other without any windows (e.g., stream processing). In some embodiments, all of event consumers 216 consume events in parallel and send data over shared queue 118 to other modules.

In some embodiments, event gate 102 is only one event gate, one of many event gates, or one of a plurality of event gates created by the service layer based upon the configuration file. In some embodiments, each event gate 102 can consume data from multiple sources having different or like interfaces, different or like configurations of consumer or sources. In some embodiments, each event gate 102 samples sources with different or like configurations of consumers 216 or data sources 202, 204, 206A, or 206B. In some embodiments, the data sink is configured to be an internal data bus, such as shared queue 118 or any other data sink.

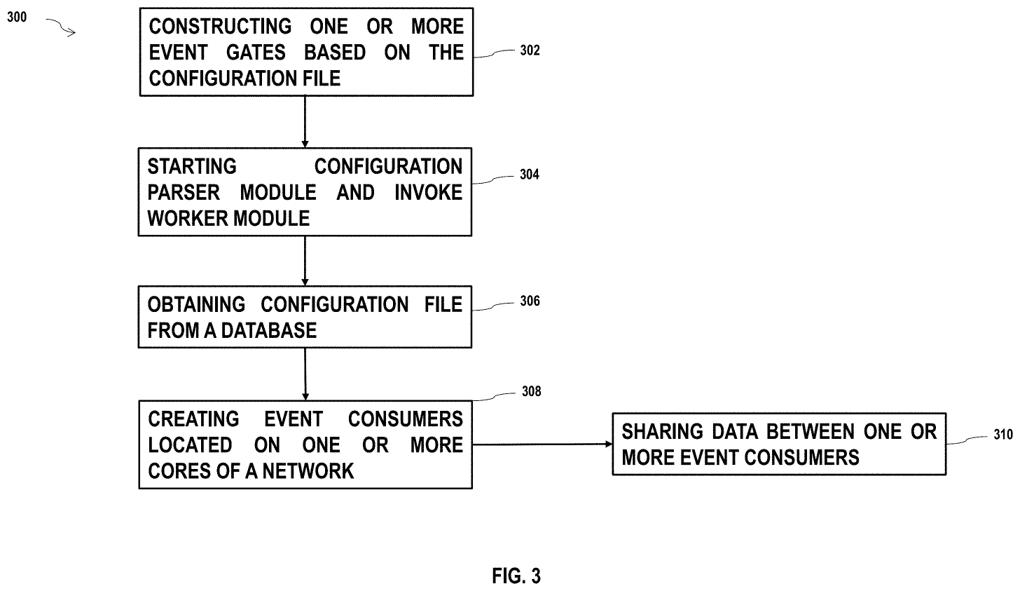

FIG. 3 is a flow 6 diagram for a method of implementing a pluggable data adaptor, in accordance with some embodiments.

Method 300 is configured to be used to implement a pluggable data adaptor for event messages. Method 300 is configured to be used in a even gate system, such as even gate system 100, to handle multiple data sources and multiple data source types. The sequence in which the operations of method 300 are depicted in FIG. 3 is for illustration only; the operations of method 300 are capable of being executed in sequences that differ from that depicted in FIG. 3. In some embodiments, operations in addition to those depicted in FIG. 3 are performed before, between, during, and/or after the operations depicted in FIG. 3.

In some embodiments, one or more of the operations of method 300 are a subset of operations of a method implementing a pluggable data adaptor. In various embodiments, one or more of the operations of method 300 are performed by using one or more processors, e.g., a processor 402 discussed below with respect to data adaptor processing circuitry 400 and FIG. 4.

At operation 302 of method 300, a service layer of a even gate system, such as even gate system 100, constructs one or more event gates based on a configuration file. The configuration file specifies configuration information for constructing a pluggable event gate, such as pluggable event gate 102. Process flows from operation 302 to operation 304.

At operation 304 of method 300, the event gate module, such as event gate module 104, initializes or starts up a configuration parser module, such as configuration parser module 106, and a invoke worker module, such as invoke worker module 108. Process flows from operation 304 to operation 306.

At operation 306 of method 300, the configuration parser module, such as configuration parser module 106, obtains the configuration file from a database, such as database 110. The configuration file specifies data sources that includes, an online data source, an offline data source, a streaming data source, or batch data source, and a data sink. Process flows from operation 306 to operation 308.

At operation 308 of method 300, an invoke worker module, such as invoke worker module 108, creates event consumers located on one or more cores of a network based on a number of the user-defined data sources and a number of user-defined data sinks within the configuration file. Process flows from operation 308 to operation 310.

At operation 310 of method 300, a shared queue, such as shared queue 118, shares data between one or more event consumers.

FIG. 4 is a block diagram of data adaptor processing circuitry 400 in accordance with some embodiments. In some embodiments, data adaptor processing circuitry 400 is a general purpose computing device including a hardware processor 402 and a non-transitory, computer-readable storage medium 404. Storage medium 404, amongst other things, is encoded with, i.e., stores, computer program code 406, i.e., a set of executable instructions such as a correlation engine and policy manager. Execution of instructions 406 by hardware processor 402 represents (at least in part) a data adaptor tool which implements a portion or all of the methods described herein in accordance with one or more embodiments (hereinafter, the noted processes and/or methods).

Processor 402 is electrically coupled to a computer-readable storage medium 404 via a bus 408. Processor 402 is also be electrically coupled to an I/O interface 410 by bus 408. A network interface 412 is also electrically connected to processor 402 via bus 408. Network interface 412 is connected to a network 414, so that processor 402 and computer-readable storage medium 404 are capable of connecting to external elements via network 414. Processor 402 is configured to execute computer program code 406 encoded in computer-readable storage medium 404 in order to cause data adaptor processing circuitry 400 to be usable for performing a portion or all of the noted processes and/or methods, such as method 300, of FIG. 3. In one or more embodiments, processor 402 is a central processing unit (CPU), a multi-processor, a distributed processing system, an application specific integrated circuit (ASIC), and/or a suitable processing unit.

In one or more embodiments, computer-readable storage medium 404 is an electronic, magnetic, optical, electromagnetic, infrared, and/or a semiconductor system (or apparatus or device). For example, computer-readable storage medium 404 includes a semiconductor or solid-state memory, a magnetic tape, a removable computer diskette, a random access memory (RAM), a read-memory (ROM), a rigid magnetic disk, and/or an optical disk. In one or more embodiments using optical disks, computer-readable storage medium 404 includes a compact disk-read memory (CD-ROM), a compact disk-read/write (CD-R/W), and/or a digital video disc (DVD).

In one or more embodiments, storage medium 404 stores computer program code 406 configured to cause data adaptor processing circuitry 400 to be usable for performing a portion or all of the noted processes and/or methods. In one or more embodiments, storage medium 404 also stores information, such a data adaptor algorithm which facilitates performing a portion or all of the noted processes and/or methods.

Data adaptor processing circuitry 400 includes I/O interface 410 that is like user input 112. I/O interface 410 is coupled to external circuitry. In one or more embodiments, I/O interface 410 includes a keyboard, keypad, mouse, trackball, trackpad, touchscreen, cursor direction keys and/or other suitable I/O interfaces are within the contemplated scope of the disclosure for communicating information and commands to processor 402.

Data adaptor processing circuitry 400 further includes network interface 412 coupled to processor 402. Network interface 412 allows data adaptor processing circuitry 400 to communicate with network 414, to which one or more other computer systems are connected. Network interface 412 includes wireless network interfaces such as BLUETOOTH, WIFI, WIMAX, GPRS, or WCDMA; or wired network interfaces such as ETHERNET, USB, or IEEE-864. In one or more embodiments, a portion or all of noted processes and/or methods, is implemented in two or more data adaptor processing circuitry 400.

Data adaptor processing circuitry 400 is configured to receive information through I/O interface 410. The information received through I/O interface 410 includes one or more of instructions, data, and/or other parameters for processing by processor 402. The information is transferred to processor 402 via bus 408. Data adaptor processing circuitry 400 is configured to receive information related to a UI through I/O interface 410. The information is stored in computer-readable medium 404 as user interface (UI) 418.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

A system of one or more computers are configured to perform particular operations or actions by virtue of having software, firmware, hardware, or a combination of them installed on the system that in operation causes or cause the system to perform the actions.

One or more computer programs are configured to perform particular operations or actions by virtue of including instructions that, when executed by data processing apparatus, cause the apparatus to perform the actions. In some embodiments, a system includes processing circuitry and a memory connected to the processing circuitry. The memory is configured to store executable instructions that, when executed by the processing circuitry, cause the processing circuitry to startup a configuration parser module and an invoke worker module. In some embodiments, cause the processing circuitry to obtain a configuration file from a database where the configuration file specifies configuration information for constructing a pluggable event gate that includes a data adaptor for an online source, a data adaptor for an offline source, a data adaptor sink, and a data adaptor channel coupled between a data adaptor source and the data adaptor sink. In some embodiments, the processing circuitry to construct one or more event gates based on the configuration file. The configuration file further specifies one or more user-defined data sources and one or more user-defined data sinks. In some embodiments, the processing circuitry to create, responsive to a number of the user-defined data sources and a number of user-defined data sinks, multiprocessing workers located on one or more cores of a network and share data between the multiprocessing workers. Other embodiments of this aspect include corresponding computer systems, apparatus, and computer programs recorded on one or more computer storage devices, each configured to perform the actions of the methods.

Implementations include one or more of the following features. The system where the processing circuitry is configured to execute the instructions to assign, by the one or more event gates, tasks for the multiprocessing workers. The processing circuitry is configured to execute the instructions to parse the configuration file obtained from the database. The processing circuitry is configured to execute the instructions to identify the number of the user-defined data sources and the configuration information of each of the user-defined data sources. The processing circuitry is configured to execute the instructions to identify the configuration of each of the multiprocessing workers. The processing circuitry is configured to execute the instructions to obtain, by a multiprocessing worker of the multiprocessing workers, events from an assigned user-defined data source. The processing circuitry is configured to execute the instructions to route, by the multiprocessing worker, the events from the assigned user-defined data source to a user-defined data sink. The processing circuitry is configured to execute the instructions to log the multiprocessing workers and the one or more event gates. The processing circuitry is configured to execute the instructions to write to an error log an event that results in an error by a multiprocessing worker of the multiprocessing workers. The processing circuitry is configured to execute the instructions to maintain rolling logs based on timestamp and size. Implementations of the described techniques include hardware, a method or process, or computer software on a computer-accessible medium.

In some embodiments, a method of ingesting multiple data sources includes starting up a configuration parser module and an invoke worker module. In some embodiments, the method includes obtaining a configuration file from a database, where the configuration file specifies configuration information for constructing a pluggable event gate that includes an online data source, an offline data source, a streaming data source, a batch data source, and a data sink. The method further includes constructing one or more event gates based on the configuration file. The configuration file specifies one or more user-defined data sources and one or more user-defined data sinks, where the user-defined data source is one or more of the online, the offline, the streaming, or the batch data sources. The method includes creating, responsive to a number of the user-defined data sources and a number of user-defined data sinks, event consumers located on one or more cores of a network. The method includes sharing data between one or more event consumers. The method further includes the initiating, the obtaining, the constructing, the creating, and the sharing are performed by processing circuitry. Other embodiments of this aspect include corresponding computer systems, apparatus, and computer programs recorded on one or more computer storage devices, each configured to perform the actions of the methods.

Implementations include one or more of the following features. The method includes grouping data from the user-defined data sources into frames. The method includes sending the frames to one or more data sinks through a real-time messaging queue. The one or more event gates are configured to accept from both the batch data source and the streaming data source. The modifying is free from code modification or stopping operation of the one or more event gates. Implementations of the described techniques include hardware, a method or process, or computer software on a computer-accessible medium.

In some embodiments, a device includes a non-transitory, tangible computer readable storage medium storing a computer program, where the computer program contains instructions that when executed, cause the device to perform operations that includes to startup a pluggable configuration parser module and a pluggable invoke worker module. The operations include to obtain a configuration file from a database. The operations also include to construct one or more event gates based on the configuration file. The configuration file specifying a user-defined data source and a user-defined data sink. In some embodiments, the operations include to create, responsive to a number of the user-defined data sources and a number of user-defined data sinks, event consumers and share data between one or more event consumers. Other embodiments of this aspect include corresponding computer systems, apparatus, and computer programs recorded on one or more computer storage devices, each configured to perform the actions of the methods.

Implementations include one or more of the following features. The operations where the configuration file specifies configuration information for constructing a pluggable event gate that includes an online data source, an offline data source, a streaming data source, a batch data source, and a data sink. The user-defined data source is one or more of the online, the offline, the streaming, or the batch data sources. Each event consumer includes processing circuitry located on a network. Implementations of the described techniques include hardware, a method or process, or computer software on a computer-accessible medium.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. A system, comprising:
processing circuitry; and
a memory connected to the processing circuitry, wherein the memory is configured to store executable instructions that, when executed by the processing circuitry, cause the processing circuitry to:
startup a configuration parser module and an invoke worker module;
obtain a configuration file from a database, wherein the configuration file specifies configuration information for constructing a pluggable event gate that includes a data adaptor for an online source, a data adaptor for an offline source, a data adaptor sink, and a data adaptor channel coupled between a data adaptor source and the data adaptor sink;
construct one or more event gates based on the configuration file, the configuration file further specifies one or more user-defined data sources and one or more user-defined data sinks;
create, responsive to a number of the user-defined data sources and a number of user-defined data sinks, multiprocessing workers located on one or more cores of a network; and
share data between the multiprocessing workers.

2. The system of claim 1, wherein the processing circuitry is configured to execute the instructions to:
assign, by the one or more event gates, tasks for the multiprocessing workers.

3. The system of claim 1, wherein the processing circuitry is configured to execute the instructions to:
parse the configuration file obtained from the database.

4. The system of claim 3, wherein the processing circuitry is configured to execute the instructions to:
identify the number of the user-defined data sources and the configuration information of each of the user-defined data sources.

5. The system of claim 3, wherein the processing circuitry is configured to execute the instructions to:
identify the configuration of each of the multiprocessing workers.

6. The system of claim 1, wherein the processing circuitry is configured to execute the instructions to:
obtain, by a multiprocessing worker of the multiprocessing workers, events from an assigned user-defined data source.

7. The system of claim 6, wherein the processing circuitry is configured to execute the instructions to:
route, by the multiprocessing worker, the events from the assigned user-defined data source to a user-defined data sink.

8. The system of claim 1, wherein the processing circuitry is configured to execute the instructions to:
log the multiprocessing workers and the one or more event gates.

9. The system of claim 1, wherein the processing circuitry is configured to execute the instructions to:
write to an error log an event that results in an error by a multiprocessing worker of the multiprocessing workers.

10. The system of claim 9, wherein the processing circuitry is configured to execute the instructions to:
maintain rolling logs based on timestamp and size.

11. A method of ingesting multiple data sources, comprising:
constructing one or more event gates based on a configuration file;
starting, by an event gate, a configuration parser module and an invoke worker module;
obtaining the configuration file from a database, the configuration file specifies one or more user-defined data sources and one or more user-defined data sinks, wherein the user-defined data source is one or more of the online, the offline, the streaming, or the batch data sources;
creating, responsive to a number of the user-defined data sources and a number of user-defined data sinks, event consumers located on one or more cores of a network;
sharing data between one or more event consumers; and
wherein the initiating, the obtaining, the constructing, the creating, and the sharing are performed by processing circuitry.

12. The method of claim 11, further comprising:
grouping data from the user-defined data sources into frames.

13. The method of claim 12, further comprising:
sending the frames to one or more data sinks through a real-time messaging que.

14. The method of claim 11, wherein the one or more event gates are configured to accept from both the batch data source and the streaming data source.

15. The method of claim 11, further comprising:
modifying the one or more event gates in real time, wherein the modifying is free from code modification or stopping operation of the one or more event gates.

16. A device comprising:
a non-transitory, tangible computer readable storage medium storing a computer program, wherein the computer program contains instructions that when executed, cause the device to perform operations comprising:
startup a pluggable configuration parser module and a pluggable invoke worker module;
obtain a configuration file from a database;
construct one or more event gates based on the configuration file, the configuration file specifying a user-defined data source and a user-defined data sink;
create, responsive to a number of the user-defined data sources and a number of user-defined data sinks, event consumers; and
sharing data between one or more event consumers.

17. The device of claim 16, wherein the configuration file specifies configuration information for constructing a pluggable event gate that includes:
an online data source;
an offline data source;
a streaming data source;
a batch data source; and
a data sink.

18. The device of claim 17, wherein the user-defined data source is one or more of the online, the offline, the streaming, or the batch data sources.

19. The device of claim 16, wherein each event consumer comprises processing circuitry located on a network.

20. The device of claim 16, wherein the one or more event consumers are configured to process events in parallel.
